(19) United States
(12) Patent Application Publication
(10) Pub. No.: US 2024/0195138 A1
(43) Pub. Date: Jun. 13, 2024

(54) Efficient Integrated Multimode Amplifiers for Scalable Long-Haul SDM Transmission

(71) Applicant: The Board of Trustees of the Leland Stanford Junior University, Stanford, CA (US)

(72) Inventors: Joseph M. KAHN, San Carlos, CA (US); Hrishikesh SRINIVAS, Stanford, CA (US); Oleksiy KRUTKO, Stanford, CA (US)

(21) Appl. No.: 18/533,407

(22) Filed: Dec. 8, 2023

Related U.S. Application Data
(60) Provisional application No. 63/431,562, filed on Dec. 9, 2022.

(51) Int. Cl. H01S 3/067; H01S 3/0915; H01S 3/13; H04J 14/00

(52) U.S. Cl. CPC H01S 3/06716; H01S 3/0915; H01S 3/13013; H04J 14/052

(57) ABSTRACT

An integrated, high-performance amplifier subsystem is based on an optimized design of a multimode erbium-doped fiber amplifier (MM-EDFA) and a wavelength- and mode-selective pump coupler (PC). The length and ring doping profile of the MM-EDF and the pump-mode powers can be optimized to obtain low mode-dependent gain (MDG), low noise figure (NF) and high power-conversion efficiency (PCE). The pump coupler can be designed with high pump-mode efficiency and low signal-mode loss by appropriate selection of the pump mode group and the index exponent of an intermediate graded-index (GI) coupling fiber.

### CROSS-REFERENCE TO RELATED APPLICATION

This application claims the benefit of U.S. Provisional Application Ser. No. 63/431,562, filed Dec. 9, 2023, the contents of which are incorporated herein by reference.

### BACKGROUND

Power-limited long-haul optical communication systems exploit power-efficient spatial-division multiplexing (SDM) to deliver higher cable capacities to meet ever-increasing worldwide demand. In current systems using parallel single-mode fibers (SMFs), SDM optimizes system power efficiency, defined as capacity per unit power, by transmitting through a larger number of fiber pairs at lower power and data rate per fiber, thereby maximizing cable capacity subject to feed-power constraints.

Alternate designs using coupled-core multicore fiber (CC-MCF) or multimode fiber (MMF) can potentially enhance integration and scalability in SDM systems, improving their power and cost efficiencies. Beneficial SDM transmission fiber characteristics have been identified and studied including ultra-low loss, large effective area and low non-linearity, and strong, random mode coupling reducing the impact of transmission fiber group delay (GD) spread and amplifier mode-dependent gain (MDG). Comparison between MMF and CC-MCF transmission fibers is ongoing, with CC-MCFs showing better performance metrics so far.

In tandem, research has addressed the requirements for MMF and CC-MCF amplifiers to support efficient SDM transmission: gain sufficient to overcome span loss, low noise figure (NF), low MDG, and high power-conversion efficiency (PCE). In particular, MDG poses greater challenges than the polarization-dependent gain (PDG) encountered in parallel SMF systems. The study quantified the impact of MDG on capacity for various regimes of link signal-to-noise ratio (SNR) evolution and various receiver architectures, and showed that strongly coupled multimode or multicore transoceanic systems require very low MDG to keep capacity losses at tolerably low levels. Apart from the doped fibers themselves, passive components in amplifier nodes, such as pump couplers, should introduce low mode-averaged loss and mode-dependent loss (MDL) for both signal and pump to minimize transmission impairments and maximize power efficiency.

Achieving the integration objectives and performance requirements in CC-MCF and MMF amplification remains challenging. Multicore amplification typically relies on complex, lossy fan-out/fan-in networks with single-mode amplifiers or inefficient, cladding-based pumping of multicore amplifiers. Multimode erbium-doped fiber amplifiers (MM-EDFAs) promise integration in SDM systems, but have been limited to date by excessive MDG and by higher NFs and lower PCEs than single-mode EDFAs. MDG reduction by optimizing EDF length and doping profile has been studied both in numerical simulations and in experiments. Control of pump modes can reduce MDG, as shown by validated modeling. MDG can be minimized effectively using more complex methods to control pump modes, including phase masks and variable attenuators, dynamically optimized spatial light modulators or optimization of numerous pump modes at two pump wavelengths. While each approach has shown promise in reducing MDG, the need remains for power-efficient, cost-effective, integrated solutions satisfying the requirements of long-haul SDM systems.

### SUMMARY

The subject matter described herein provides, in one aspect, an integrated, high-performance amplifier subsystem based on an optimized design of a MM-EDFA and a wavelength- and mode-selective pump coupler (PC). In some embodiments the length and ring doping profile of the MM-EDF and the pump-mode powers are optimized to obtain low MDG, low NF and high PCE. Likewise, by judiciously choosing the pump mode group and the index exponent of an intermediate GI coupling fiber, a pump coupler can be designed with high pump-mode efficiency and low signal-mode loss. In some embodiments the subsystem uses fewer pump laser diodes per signal mode than parallel SMF-based systems, and may provide a path for economical, efficient scaling of SDM long-haul systems.

In one particular embodiment, a MM-EDFA subsystem is provided for six spatial modes based on a graded-index (GI) EDF with optimized ring doping profile, length and pump mode powers. The subsystem uses a wavelength- and mode-selective pump coupler (PC) to efficiently couple in four pump modes, while passing the signal modes with minimal loss. Detailed numerical modeling of the MM-EDFA and the PC are presented, showing that the design promises low MDG, low NF and high PCE over the C-band at signal powers typical for long-haul SDM systems. Although the detailed scheme is presented for a MMF EDFA, where it enables fewer pump modes than signal modes, those of ordinary skill in the art will recognize that the subject matter described herein also encompasses CC-MCF EDFAs by appropriate redesign of the PC.

In accordance with other embodiments of the present disclosure, an optical fiber amplifier subsystem is provided. The optical fiber amplifier subsystem includes an optical fiber selected from the group consisting of a multimode fiber (MMF) and a coupled-core multi-core fiber (CC-MCF), a gain medium configured to provide gain for Nₛₑ guided signal spatial modes in the optical fiber and at least one pump light source configured to provide pump light at a pump wavelength to the gain medium. A pump coupler is configured to perform propagation constant matching to effect mode-selective evanescent field coupling of the pump light to Nₚₑ guided pump modes in the optical fiber, where Nₛₑ is an integer specifying a number of guided signal spatial modes to be excited and Nₚₑ is an integer specifying a number of guided pump spatial modes to be excited, and Nₚₑ<Nₛₑ and Nₚₑ>1.

In accordance with yet other embodiments of the present disclosure, a spatial-division multiplexing (SDM) optical transmission system is provided. The system includes first and second terminals and an optical path that operatively couples the first terminal to the second terminal. The optical path includes at least one optical fiber configured to support a plurality of spatial modes at a given optical wavelength. At least one multimode optical amplifier subsystem is disposed along the optical path for amplifying the plurality of spatial modes propagating in the optical fiber. The at least one multimode optical amplifier subsystem includes a gain medium configured to provide gain for Nₛₑ guided signal spatial modes in the optical fiber and at least one pump light source configured to provide pump light at a pump wavelength to the gain medium. A pump coupler is configured to perform propagation constant matching to effect mode-selective evanescent field coupling of the pump light to Nₚₑ guided pump spatial modes in the optical fiber, where Nₛₑ is an integer specifying a number of guided signal spatial modes to be excited and Nₚₑ is an integer specifying a number of guided pump spatial modes to be excited, and Nₚₑ<Nₛₑ and Nₚₑ>1.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing one example of a multimode amplifier subsystem in accordance with the present disclosure.

FIG. 2 shows the axially symmetric, trench-assisted graded index (GI) relative refractive index profile of the transmission and amplifier fibers that is employed in one embodiment of the multimode amplifier subsystem described herein.

FIG. 3 is a schematic diagram of one example of a wavelength- and mode-selective pump coupler (PC) for coupling four pump modes at 980 nm into intermediate graded index (GI) coupling fiber with six co-propagating signal modes near 1550 nm.

FIGS. 4(a)-4(c) show the modal gain (top row) and NF curves (bottom row) for the amplifiers of Table 3 obtained by forward simulation over 40 wavelengths in the C-band for the input signal powers per mode of −5 (FIG. 4a), 0 (FIG. 4b) 5 dBm (FIG. 4c), or −21, −16, −11 dBm per mode per wavelength, respectively.

FIG. 5(a) shows the mode-dependent gain (MDG) standard deviation (STD) σ_{g} vs. wavelength curves for the optimized MM-EDFs of Table 3 at the input signal power per mode values shown, as obtained from forward simulation over 40 wavelengths in the C-band; and FIG. 5(b) shows the corresponding mode-averaged linear NF vs. wavelength curves.

FIGS. 6(a) and 6(b) respectively show the splice losses and coupler losses of the PC for the six signal modes as a function of wavelength.

FIG. 7 shows the coupling efficiencies of the second mode-selective coupler (MSC) in FIG. 3 to the LP_{31b} and LP₃₁ₐ modes vs. angular offset from its nominal position, 90° from the first MSC and the coupling efficiencies of the fourth MSC to the LP1_{2b} and LP₁₂ₐ modes vs. angular offset from its nominal position, 90° from the third MSC.

FIG. 8 shows the amplifier optical-to-optical power-conversion efficiencies (PCEs) with pump power per signal spatial mode (Pₚ/6), for the MM-EDFAs with optimized length, doping radii and pump powers in Table 3 (squares), and those for the MM-EDFAs with fixed length of 1 m, full doping up to 17.25 μm, and optimized pump powers only in Table 4 (diamonds).

FIG. 9 illustrates one example of an SDM optical transmission system that may employ the optical amplifier subsystem described herein.

### DETAILED DESCRIPTION

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

### I. Basic Definitions and Terminology

In order to facilitate an understanding of the embodiments described herein, a number of terms are defined below.

### A. Types of Fibers

The systems and methods described herein are concerned with two types of optical fibers: multimode fibers (MMFs) and coupled-core multi-core fibers (CC-MCFs). Typically, the multimode fibers have a graded-index (GI) profile, and are denoted by GI-MMFs.

### B. Modes

Unless noted otherwise, the term made refers to a guided mode (also known as a propagating mode or a bound mode). A guided mode is an eigen-solution of the wave equation describing the propagation of light in the fiber that is guided, i.e., propagates a long distance (at least many meters) while remaining confined within the fiber. Solution of the wave equation provides a description of the electromagnetic fields associated with each mode. In typical glass fibers, a mode is considered to be fully specified by the amplitude and direction of its electric field vector as a function of the spatial coordinates. As a mode propagates along the fiber's z axis, neglecting attenuation, the electric field amplitude is scaled by the eigenvalue of the mode, which is given by e^{iβz}, where β is the mode's propagation constant.

### C. Spatial Modes

In fibers typically used for transmitting signals in telecommunications, it is typically considered sufficient to characterize modal electric fields by their transverse components, which lie in an (x,y) or (ρ,ϕ) plane, which is perpendicular to the z direction. This simplified characterization is justified, for example, when the fibers are weakly guiding, i.e., when the index difference between the core(s) and the cladding is small compared to unity. The transverse components of the modal electric fields are typically characterized by a spatial mode, which describes the amplitude of the electric field as a function of (x,y) or (ρ,ϕ), and by a polarization, which describes the direction of the electric field vector. The electric field amplitudes of different spatial modes are mutually orthogonal functions of (x,y) or (ρ,ϕ). Given any one spatial mode, there correspond two separate modes: one mode polarized along x and another polarized along y (or, more generally, in two arbitrary, mutually orthogonal polarizations, which are generally elliptical). These two modes share the same electric field amplitude distributions as a function of (x,y) or (ρ,ϕ), and have very nearly identical propagation constants. These two modes are mutually orthogonal, owing to their orthogonal polarizations.

A spatial mode group is a set of spatial modes that have identical or nearly identical propagation constants.

### D. Linearly Polarized Modes

When characterizing modal electric fields by their transverse components, as is common practice for weakly guiding fibers, the transverse electric fields are often referred to as linearly polarized modes. While the term may refer to either spatial modes (specifying only the electric field amplitude distribution) or to modes (also specifying the electric field polarization), unless noted otherwise, we use it here to designate spatial modes.

In fibers with axially symmetric cores, the linearly polarized spatial modes are often designated by LPₗₘ, where l is an azimuthal mode index, which may assume values 0, 1, 2, 3, . . . , and m is a radial mode index, which may assume values 1, 2, 3, . . . . If the azimuthal index l is zero, LP₀ₘ describes a single axially symmetric spatial mode with transverse field amplitude distribution R₀ₘ(ρ). If the azimuthal index l is non-zero, LPₗₘ describes a pair of mutually orthogonal, degenerate spatial modes, designated by LP_{lm,a} and LP_{lm,b}, which have transverse field amplitude distributions Rₗₘ(ρ)cos(lϕ) and Rₗₘ(ρ)sin(lϕ), respectively. In all cases, the radial mode index m corresponds to the number of values of ρ at which Rₗₘ(ρ) vanishes.

### E. Number of Spatial Modes

We let N denote the total number of spatial modes guided in a fiber at a given wavelength. N depends on design parameters that include the core radius, the core-to-cladding refractive index difference, and the wavelength of the light. Generally, N increases as we increase the core radius, increase the core-to-cladding refractive index difference, and decrease the wavelength of the light.

In a GI-MMF, the fundamental LP₀₁ spatial mode is non-degenerate, so it forms a group of 1 spatial mode, while the higher-order spatial mode groups include 2, 3, 4, 5, 6, 7, . . . spatial modes, respectively. Thus, the total number of guided spatial modes N at a given wavelength typically assumes values N=1, 3, 6, 10, 15, 21, 28, . . . , respectively.

Table 1 shows the seven lowest-order spatial-mode groups in a GI-MMF.

TABLE 1

| Mode Group | | |
|---|---|---|
| Number (Number of | Cumulative Total | |
| Guided Spatial | Number of Guided | Linearly Polarized |
| Modes) | Spatial Modes N | Spatial Modes |
| 1 | 1 | LP₀₁ |
| 2 | 3 | LP_{11, a}, LP_{11, b} |
| 3 | 6 | LP_{21, a}, LP_{21, b}, LP₀₂ |
| 4 | 10 | LP_{31, a}, LP_{31, b}, LP_{12, a}, LP_{12, b} |
| 5 | 15 | LP_{41, a}, LP_{41, b}, LP_{22, a}, LP_{22, b}, LP₀₃ |
| 6 | 21 | LP_{51, a}, LP_{51, b}, LP_{32, a}, LP_{32, b}, LP_{13, a}, LP_{13, b} |
| 7 | 28 | LP_{61, a}, LP_{61, b}, LP_{42, a}, LP_{42, b}, LP_{23, a}, LP_{23, b}, LP₀₄ |

In the CC-MCFs of interest, if there are N_{c} cores and, at a given wavelength, each core supports N₀ guided spatial modes per core, then the total number of guided spatial modes is given by N=N_{c}×N₀. The term CC-MCF is typically used to describe an MCF when at least some of the guided spatial modes are coupled between the different cores. For a given spatial mode at a given wavelength, generally, the coupling is stronger if the cores are arrayed more closely together. For a given spacing between the cores, generally, the coupling is stronger for higher-order modes than for lower-order modes, and is stronger for longer wavelengths than for shorter wavelengths. The coupled modes in a coupled-core multicore fiber are often called supermodes. If the LP₀₁ modes in a CC-MCF are coupled, then the lowest-order spatial supermodes of the CC-MCF are a group of N_{c} spatial modes, which are well-approximated (to first order in the strength of coupling between the cores) by N_{c} mutually orthogonal linear combinations of the LP₀₁ modes of the individual cores. Similarly, if the LP₁₁ modes in a CC-MCF are guided and are coupled, then the first higher-order spatial supermodes of the CC-MCF are a group of 2N_{c} spatial modes, which are well-approximated by 2N_{c} mutually orthogonal linear combinations of the LP_{11,a} and LP_{11,b} modes of the individual cores.

### F. Number of Modes Including Spatial and Polarization Degrees of Freedom

The fibers used for data transmission in telecommunications are typically weakly guiding, and unless noted otherwise, we consider weakly guiding fibers. Assuming weak guidance, if we let N denote the total number of orthogonal guided spatial modes in a fiber at a certain wavelength, then including both polarizations, the total number of orthogonal guided modes at that wavelength will be D=2N. In most of the following, we only specify N, the number of spatial modes that can propagate in a fiber, but it should be understood that the total number of modes that can propagate is twice that, D=2N. Likewise, if we state that signal light or pump light is launched into a certain set of spatial modes, it should be understood that the signal or pump may propagate in two orthogonal modes for each of those spatial modes, corresponding to the two orthogonal polarizations.

### G. Signal and Pump Modes Employed in Fiber Amplifiers

Consider an MMF or CC-MCF with a given refractive index profile. At a signal wavelength λₛ (typically near 1550 nm), let Nₛ denote the total number of spatial modes guided by the fiber. At a pump wavelength λₚ (typically near 980 nm), let Nₚ denote the total number of spatial modes guided by the fiber. Since λₚ<λₛ, in typical cases, we have Nₚ>Nₛ.

In the fiber amplifiers described herein, we do not always excite all of the pump or signal modes that can propagate in a fiber at the respective pump and signal wavelengths.

At a pump wavelength λₚ, let Nₚₑ denote the total number of pump spatial modes that are substantially excited. We are typically free to choose Nₚₑ by appropriately designing the pumping system, especially the number and configuration of the pump couplers and pump laser diodes. In some embodiments, a pump spatial mode is considered to be substantially excited if the power coupled into that spatial mode is at least 20% of the maximum power coupled into any pump spatial mode. In other embodiments, a pump spatial mode is considered to be substantially excited if the power coupled into that spatial mode is at least 10% of the maximum power coupled into any pump spatial mode. Unless stated otherwise, we measure Nₚ and Nₚₑ at the input section of the fiber in which the gain medium (e.g., the erbium doping) resides.

At a signal wavelength λₛ, let Nₛₑ denote the total number of signal spatial modes that are substantially excited. In general, we are free to choose Nₛₑ by appropriately designing the transmission system, including the transmitter mode multiplexer, as well as the transmission fiber and other inline components. In some embodiments, a signal spatial mode is considered to be substantially excited if the power coupled into that spatial mode is at least 20% of the maximum power coupled into any signal spatial mode. In other embodiments, a signal spatial mode is considered to be substantially excited if the power coupled into that spatial mode is at least 10% of the maximum power coupled into any signal spatial mode. Unless stated otherwise, we measure Nₛ and Nₛₑ at the output of the transmitter mode multiplexer.

### II. Amplifier Subsystem Design

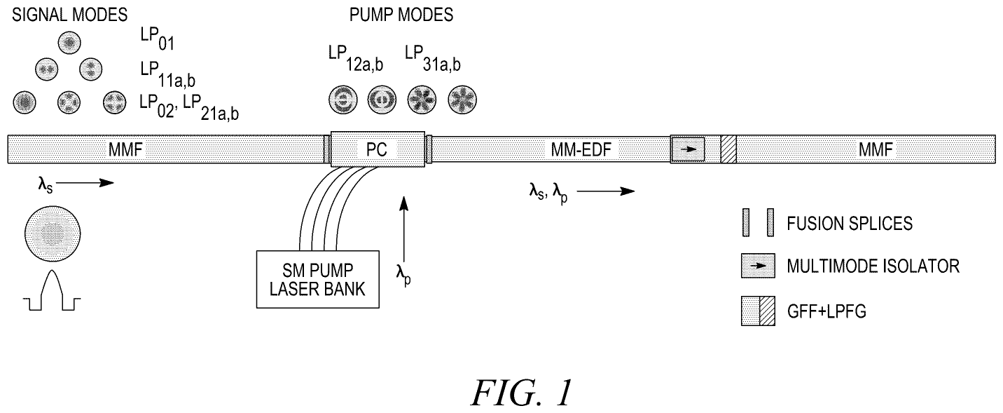

FIG. 1 is a schematic diagram showing one example of a multimode amplifier subsystem in accordance with the present disclosure. Signals in six spatial modes at wavelength λₛ in the C-band are received in a transmission MMF. The outputs of four mutually incoherent pump laser diodes pass through SMFs to the PC, where they couple to four pump spatial modes at λₚ=980 nm. After amplification in the MM-EDF, signals pass through a multimode isolator with pump-blocking filter, a gain-flattening filter (GFF), and possibly a mode-scrambling long-period fiber Bragg grating (LPFG), before exiting through a transmission MMF.

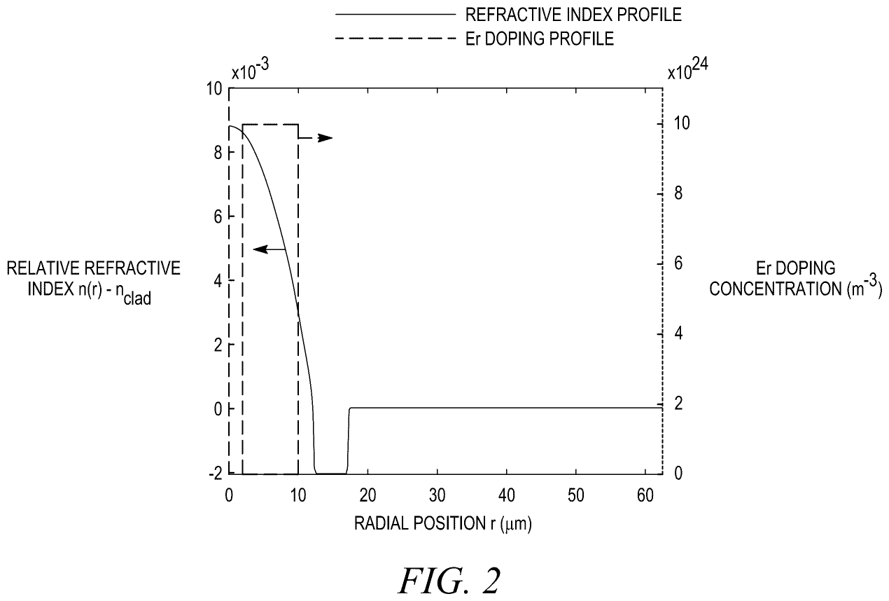

For purposes of illustration the transmission and amplifier fibers are assumed to have the axially symmetric, trench-assisted GI relative refractive index profile shown in FIG. 2. This profile has an index exponent of α=2, a core diameter of 25 μm, an overall diameter of 125 μm, and supports 6 LP spatial modes (D=12 spatial and polarization modes) over the C-band. A 5 μm-wide trench helps minimize micro- and macro-bending losses. The transmission fiber glass may be F-doped silica for ultra-low intrinsic loss, and the index contrast assumed in this illustrative example is consistent with pure silica in the center of the core and a maximum of 2.5% wt. F doping in the trench. The mode-averaged chromatic dispersion ranges from 19 to 23 ps/nm/km as the wavelength varies from 1530 to 1565 nm, while the modal effective areas at 1550 nm range from 120 μm² for the LP₀₁ mode to 240 μm² for the LP₀₂ mode. Simulated guided- and leaky-mode bending losses at signal wavelengths conform to the requirements of standards. Illustrative modifications to the transmission fiber index profile that may be employed in some embodiments that minimize GD spread are discussed in Section IV-C.

For illustrative purposes signals received at the amplifier subsystem are assumed to have undergone a span loss of 10 dB, including transmission fiber, in-line components and coupling losses, thus defining the minimum amplifier gain required.

The following two subsections describe the design of the amplifier, including the erbium doping profile and choice of pump modes, then describe the design of the mode- and wavelength-selective PC.

### A. Amplifier Design

The multimode amplifier may be modeled by solving steady-state rate equations for the Er³⁺ ion level populations, coupled-mode propagation equations for the evolution of signal and pump mode fields, and power propagation equations for the noise powers along the length of the amplifier. Although signal and pump mode evolution may be modeled using power propagation equations, the coupled-mode-field equations ensure accurate computation of gain and MDG. The signal and pump mode fields and associated propagation constants are computed in a radially resolved cylindrical geometry, as described in P. S. Anisimov et al., “Fast multi step-index mode solver for analysis and optimization of optical fiber performance,” J. Lightw. Technol., vol. 40, no. 9, pp. 2980-2987, May 2022, which is hereby incorporated by reference in its entirety.

To capture the effects of mode beating and mode coupling in the MM-EDF, the approach employed herein follows that described in R. N. Mahalati et al., “Adaptive modal gain equalization techniques in multi-mode erbium-doped fiber amplifiers,” J. Lightw. Technol., vol. 32, no. 11, pp. 2133-2143, June 2014 and J.-B. Trinel et al., “Theoretical study of gain-induced mode coupling and mode beating in few-mode optical fiber amplifiers,” Op. Exp., vol. 25, no. 3, pp. 2377-2390, 2017, each of which are hereby incorporated by reference in their entirety. However, the approach used herein has two main differences from the approach employed in the R. N. Mahalati et al. reference. First, coupling between pump modes is not assumed negligible, and second, the total local intensity at the pump wavelength is obtained by incoherent addition of the pump modes, assuming pump farming of mutually incoherent laser sources. Amplified spontaneous emission (ASE) noise evolution is modeled using power propagation equations, as in the J.-B. Trinel et al. reference. The EDF absorption and gain cross sections and doping concentration of 9.96 10²⁴ m⁻³ are those of the single-mode EDF used in the experiments described in H. Srinivas et al., “Modeling and experimental measurement of power efficiency for power-limited SDM submarine transmission systems,” J. Lightw. Technol., vol. 39, no. 8, pp. 2376 2386, April 2021 and J. D. Downie et al., “Experimental characterization of power efficiency for power-limited SDM submarine transmission systems,” in Proc. 46th Eur. Conf. Opt. Commun., 2020, pp. 1-4, each of which are hereby incorporated by reference in their entirety. These EDF properties are independent of fiber geometry and should be representative of MM-EDFs.

A primary objective of some embodiments described herein is to minimize the amplifier MDG STD and mode-averaged linear NF, both expressed in dB, while ensuring that the mode- and wavelength-dependent gains are not less than the span attenuation (see Appendix A). Note that in strongly coupled long-haul links, the impact of MDG depends on σ_{g}, which is the STD of the modal gains, each expressed in dB while the impact of ASE can be quantified in terms of 10 times the base-10 logarithm of the mean of the modal NFs, each expressed in W/W. We use a particle swarm optimization (PSO) algorithm to optimize the length and inner and outer doping radii of the EDF, along with the powers of the four pump modes in the fourth mode group (LP₁₂ₐ, LP_{12b}, LP₃₁ₐ, LP_{31b}) at pump wavelength λₚ=980 nm.

The optimizations should favor realizations with mode- and wavelength-dependent gains above yet close to the 10-dB span attenuation, and mode- and wavelength-dependent NFs above yet close to 3 dB, so the objective is formed from the RMS deviations of the two terms from these desired values, with a penalty Φ multiplying the objective for realizations whose computed gains or NFs fall outside the range of desired values. The calculated objective thus takes the form:

Φ(G+θF), (1)

where G is the RMS deviation from the target gain values set to overcome the total span attenuation at all wavelengths for all modes, F is the RMS deviation from 3 dB of the mode-averaged linear NFs expressed in dB, and Φ=1 (Φ>>1) for realizations with gain and NF values inside (outside) the range of interest, in this case, with modal gains between the 10-dB span attenuation and up to 2 dB greater, and modal NFs over 3 dB. Finally, θ is a weighting parameter tuning the relative priorities of the two terms summed in the objective. We take Φ=1000, and set θ as a heuristic value between 0 and 1; in the results shown here, θ=¼ except for the lowest input signal power per mode of 5 dBm, where we choose θ=½. We choose bounds for the optimized parameters as: pump spatial mode power less than 300 mW, maximum possible EDF length of 2 m, and doping radii allowed to vary freely within the fiber core and trench. In general, the choice of maximum EDF length will depend on the erbium doping concentration and fiber core diameter. The value of 2 m is chosen here based on preliminary optimizations, which all converged to solutions with EDF lengths above but close to 1 m, and suitably low pump powers. Optimizations with maximum EDF lengths of 5 m or 10 m produced the same solutions.

The PSO algorithm of MATLAB is used with a swarm size of 500, objective function stopping tolerance of 10⁻³, and at most 10 stall iterations. To speed up computations using the MM-EDFA model within the optimization iterations while ensuring good performance over the C-band, we make two adjustments: first, in the optimization iterations we discount the coupling terms from the amplifier coupled-mode propagation equations, which are typically orders of magnitude lower than the gain coefficients of the modes themselves, and put them back in for the forward evaluation of the performance achieved with the optimized parameters; second, we perform the optimization at only two wavelengths, 1530 nm and 1565 nm, and after optimization, perform a forward evaluation by running simulations with the optimized parameters for 40 wavelengths, while holding the total power over all signal modes and wavelengths constant. We specify the target values at the two wavelengths to be equal to (10+μ) dB, where μ is a margin added to the nominal 10-dB span loss at both wavelengths to ensure the gain is not less than the span loss at all wavelengths in between, accounting for variations in the shape of the gain spectrum. In the results shown here, μ=1.25 dB at both wavelengths, except in the case of the highest input signal power per mode of 5 dBm, where μ=1.75 dB at 1530 nm. For the procedure outlined here, an optimization run on the Stanford Sherlock HPC cluster using 32 cores with 32 GB RAM in parallel completes within 16 hours.

The choice of μ may be fine-tuned by system designers. For example, higher margins may be added to accommodate different per-span losses, and the target gain may be specified at more than two wavelengths, or over each of the six spatial modes in order to compensate for possible systematic mode-dependent losses in the transmission system.

### B. Pump Coupler Design

In some embodiments, the wavelength- and mode-selective PC is designed to efficiently couple pump light into the fourth mode group at 980 nm (LP₁₂ₐ, LP_{12b}, LP₃₁ₐ, LP_{31b}), while transmitting the six co-propagating signal modes near 1550 nm. We employ weakly coupled mode-selective couplers (MSCs), which operate by matching the propagation constants of a desired mode in a MMF and the fundamental mode in a closely positioned SMF. MSCs and tapered-velocity MSCs are often used for mode-selective (de)multiplexing of signal modes in the C-band. For our wavelength- and mode-selective PC, the design objectives are somewhat different:
i) high coupling efficiency to the desired pump modes at 980 nm,
ii) minimal power transfer to other pump modes at 980 nm,
iii) minimal loss for the signal modes near 1550 nm, and
iv) coupling lengths not exceeding a few centimeters.

An MSC designed to couple into low-order pump modes at 980 nm would struggle to meet requirements iii) and iv). These low-order modes are strongly confined, and have weak evanescent fields. Coupling to them within a coupling length of centimeters would require positioning the SMF very close to the MMF core, which would cause excessive losses for the signal modes. As a consequence, only MSCs designed to couple into the fourth or fifth pump mode group can meet all the requirements i)-iv).

MSC design is based on coupled-mode theory. Considering a simple case in which there is only one mode in a MMF with non-zero coupling to the SMF, the maximum coupling efficiency of the MSC is given by:

$$η \approx \frac{1}{1 + {( \frac{Δ β}{2 c} )}^{2}} \qquad ( 2 )$$

where Δβ is the difference between the modal propagation constants and C is the coupling coefficient between the two modes. The maximum coupling efficiency η approaches 100% when the propagation constants of the two modes are equal. The length at which maximum power transfer occurs is:

$${L}_{C} = \frac{n \sqrt{η}}{2 C} \qquad ( 3 )$$

Hence, the larger the coupling coefficient C, the shorter the coupling length L_{C}.

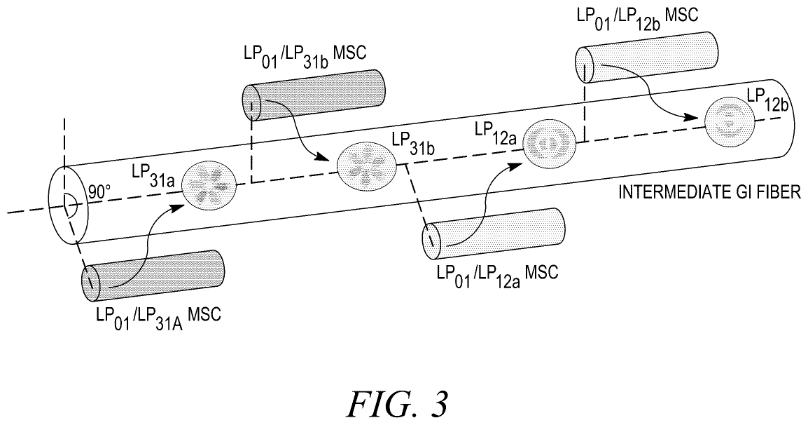

FIG. 3 is schematic diagram of one example of a wavelength- and mode-selective PC for coupling four pump modes at 980 nm into intermediate GI coupling fiber with six co-propagating signal modes near 1550 nm. The PC is composed of two LP₀₁/LP₃₁ mode-selective couplers (MSCs) and two LP₀₁/LP₁₂ MSCs in series. Within each pair, the first and second MSCs are angularly separated by 90° to couple independently into the a and b modes, respectively.

Two different MSCs are designed for coupling into either the LP₁₂ or LP₃₁ modes. Each LP mode LPₗₘ, with non-zero azimuthal number l, contains two orthogonal and degenerate spatial modes LPₗₘₐ and LP_{lmb} with transverse field profiles Rₗₘ(r) cos(lφ) or Rₗₘ(r) sin(lφ), respectively. Therefore, we can independently couple into the a and b modes by positioning two identical SMF cores in series separated by angle π/2 l+nπ/l for n=0, 1, 2, . . . A π/2 rotation between these two identical cores, as shown in FIG. 3, enables independent coupling into the a and b modes. It is important to couple mutually incoherent sources into the LPₗₘₐ and LP_{lmb} so the pump mode fields add incoherently to maintain an axially symmetric pump power distribution. Coherent addition of the pump mode fields would induce a non-axially symmetric pump power distribution that would depend on the phase difference between modes. This would induce unwanted differences in gain between degenerate signal modes.

Coupling to the pump modes in the transmission or amplification MMFs, which have the index profile shown in FIG. 2, would be challenging. While trench-assisted GI fibers with α≈2 are suitable for transmission, these fibers have mode degeneracies that are not conducive to mode-selective coupling. Since the LP₁₂ and LP₃₁ modes are nearly degenerate in these fibers, an MSC using an SMF phase-matched to the LP₁₂ pump mode would also simultaneously couple to the LP₃ᵢ pump mode, causing undesirable coherent addition of pump modes. Moreover, the trench greatly reduces the coupling coefficient by suppressing the evanescent fields of the fiber modes, making the coupling efficiency more sensitive to propagation constant mismatch, and increasing the coupling length. We therefore design an intermediate GI fiber for coupling. The intermediate fiber is a trench-less GI fiber with α=1.6, core relative index difference Δ=0.63%, and core radius r_{core}=13 μm. This value of a breaks the unwanted near-degeneracy between the desired pump modes. The MSCs can now be designed conventionally to use SMF cores phase-matched to the individual pump modes. Splicing from the transmission fiber to the intermediate fiber and back will cause loss, which will be quantified in Section III-B.

The characteristics of the LP₀₁/LP₁₂ and LP₀₁/LP₃₁ MSCs are given in Table 2. The phase-matched SMFs are step-index fibers defined by the core radius r_{core} and relative index difference Δ. The core radius of the phase-matched SMFs is fixed at 1 μm, while the relative index difference is allowed to vary. The distance between cores is d=18 μm for both MSCs. This distance is chosen to ensure a coupling coefficient small enough to maintain minimal power transfer to unwanted LP modes and large enough to achieve a coupling length of the order of centimeters. The performance of the MSC designs will be discussed in Section III-B.

TABLE 2
MODE-SELECTIVE COUPLER DESIGN PARAMETERS

| | r_{core} (μm) | Δ | d (μm) | L_{C} (cm) |
|---|---|---|---|---|
| LP₀₁/LP₁₂ | 1 | 11.354 × 10⁻³ | 18 | 5.150 |
| LP₀₁/LP₃₁ | 1 | 11.495 × 10⁻³ | 18 | 3.226 |

### III. Results

### A. Amplifier Performance

Optimizing the amplifier as described in Section II-A at the 1530 and 1565 nm wavelengths over a range of input signal powers, we obtain the MM-EDF parameters shown in the center columns of Table 3, along with the resulting minimized MDG STD σ_{g} and mode-averaged linear NF values shown in the right columns. The lowest MDG values are achieved with input signal powers per spatial mode from 0 to 2.5 dBm. The NFs decrease slightly with increasing input signal power and, as expected, decrease significantly with increasing wavelength. The optimized EDF lengths, which are of the order of just 1 m, as in 27, decrease slightly with increasing input signal power. The optimized ring-doped region expands with increasing input signal power, presumably because at higher powers, inner- and outer-core doping regions may be better inverted. The optimized pump powers increase with increasing input signal power, as expected. At all input signal powers, there is a clear preference for higher power in the LP₁₂ pump modes than in the LP₃₁ pump modes, presumably because the former overlap more strongly than the latter with the collective signal modes.

TABLE 3
MULTIMODE AMPLIFIER PARAMETERS OPTIMIZED AT TWO WAVELENGTHS

| EDFA input signal | EDF | Doping | radius (μm) | Pump mode | power (mW) | MDG STD | σ_{g} (dB) | Mode-averaged | linear NF (dB) |
|---|---|---|---|---|---|---|---|---|---|
| power per mode (dBm) | length (m) | Inner | Outer | LP_{12a, b} | LP_{31a, b} | 1530 nm | 1565 nm | 1530 nm | 1565 nm |
| −5.0 | 1.148 | 1.45 | 10.69 | 50.5 | 21.4 | 0.25 | 0.43 | 5.15 | 3.74 |
| −2.5 | 1.116 | 0.24 | 11.06 | 61.3 | 34.3 | 0.08 | 0.25 | 5.10 | 3.73 |
| 0 | 1.096 | 0.00 | 11.97 | 93.3 | 49.3 | 0.02 | 0.12 | 5.05 | 3.72 |
| 2.5 | 1.084 | 0.00 | 14.72 | 152.0 | 73.8 | 0.01 | 0.04 | 5.02 | 3.71 |
| 5.0 | 1.048 | 0.33 | 17.20 | 259.3 | 136.2 | 0.22 | 0.08 | 4.81 | 3.64 |

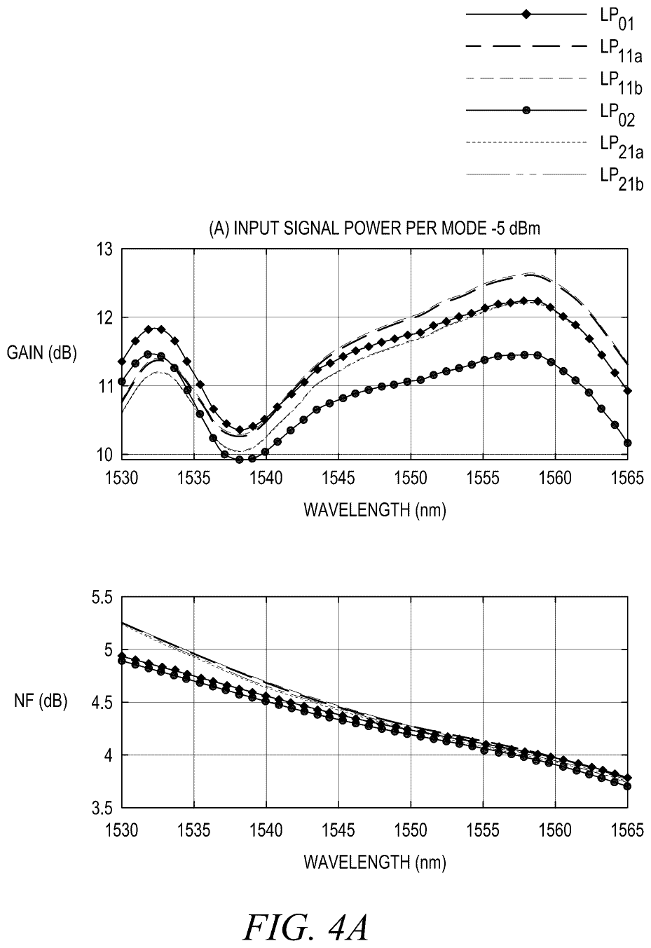

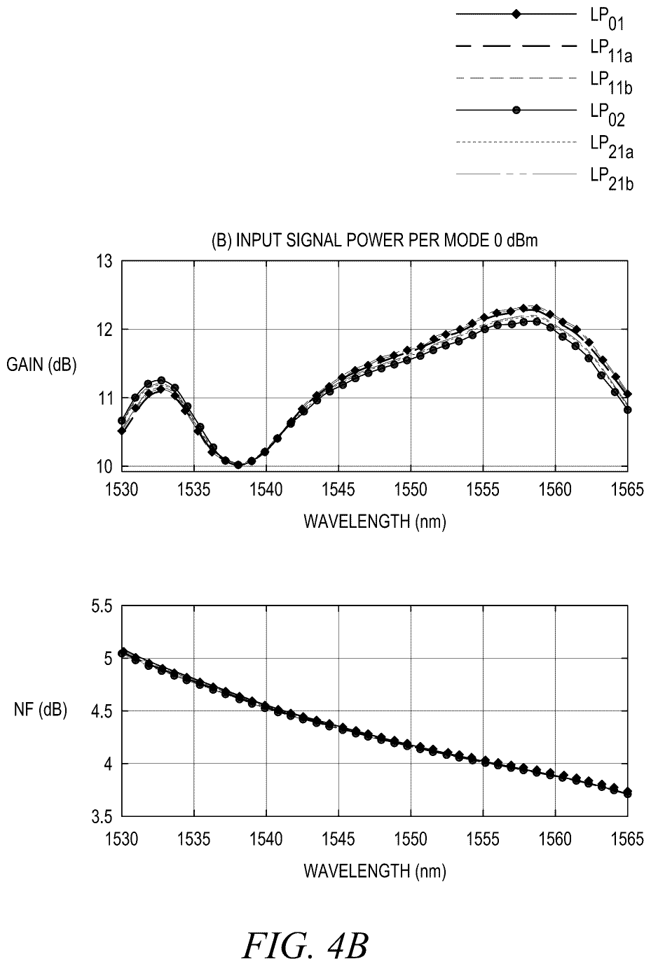

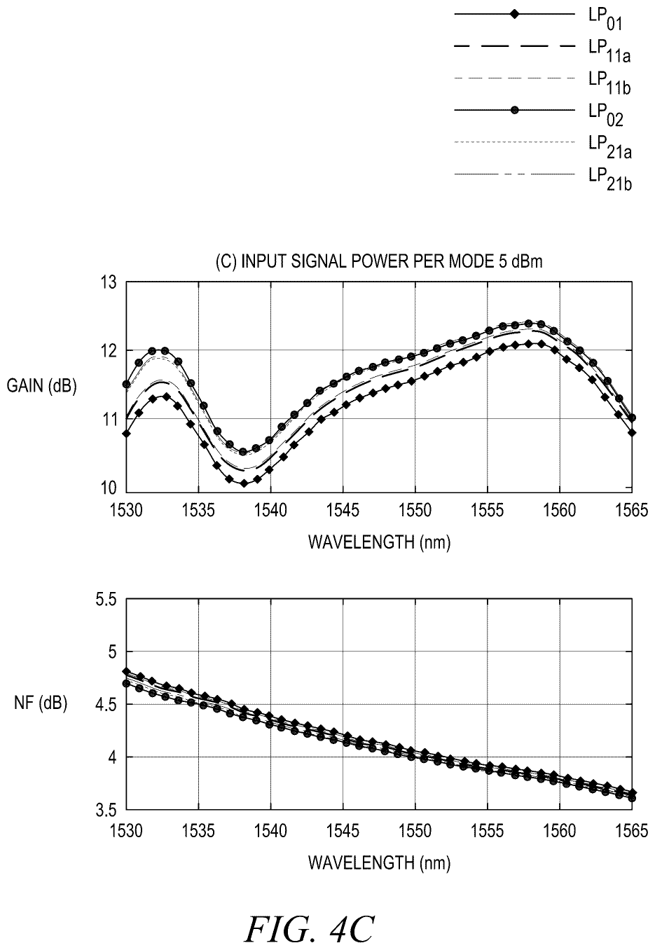

FIG. 4 shows the modal gain (top row) and NF curves (bottom row) for the amplifiers of Table 3 obtained by forward simulation over 40 wavelengths in the C-band for the input signal powers per mode of −5 (FIG. 4a), 0 (FIG. 4b) 5 dBm, or −21, −16, −11 (FIG. 4c) dBm per mode per wavelength, respectively. At all input signal powers, at least 10 dB of gain is provided across the C-band to compensate for the overall span loss (this includes the multimode isolator and GFF+LPFG shown in FIG. 1, which may induce up to 2 dB mode-averaged loss). Forward simulations over 20 wavelengths with 3 dB higher input powers (or 10 wavelengths with 6 dB higher powers) yield similar modal gains and NFs, affirming the sufficiency of simulating 40 wavelengths.

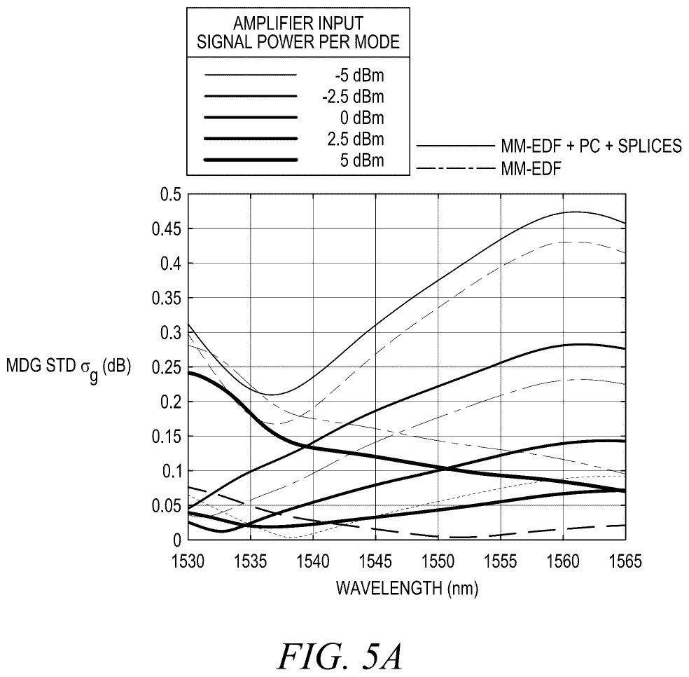

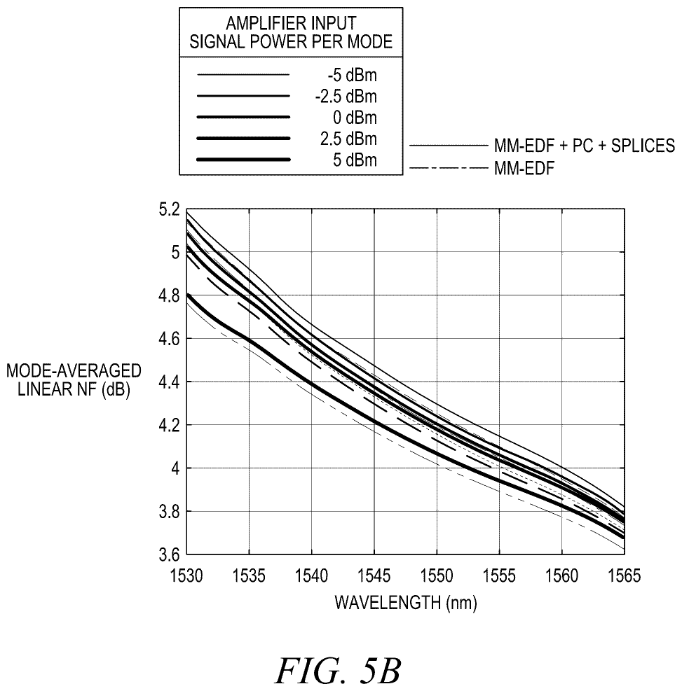

FIG. 5(a) presents the MDG STD σ_{g} vs. wavelength curves for the optimized MM-EDFs of Table 3 at the input signal power per mode values shown, as obtained from forward simulation over 40 wavelengths in the C-band. The dot-dashed curves represent the performance of the MM-EDFs alone, while the solid curves also include PC and splice losses, which are evaluated in detail in the following subsection. The trends of optimized MDG with input signal power per mode are similar to those in Table 3, with the lowest MDG STD of σ_{g}<0.1 dB over the entire C-band obtained at an input signal power of 2.5 dBm.

FIG. 5(b) presents the corresponding mode-averaged linear NF vs. wavelength curves. The legend in (a) also applies to (b). The trends of optimized amplifier NFs are again similar to those in Table 3, decreasing with increasing input signal power and with increasing wavelength, with a variation over the C-band of 1.15 to 1.4 dB.

Finally, we explore the performance achievable over a range of input signal powers if the MM-EDF design is fixed and only the pump mode powers are optimized. The MM-EDF has 1 m length and full-core doping up to 17.25 μm radius, with 9.96×10²⁴ m⁻³ doping concentration. The results, presented in Table 4, exhibit trends similar to Table 3, with generally higher optimized pump powers, higher MDG STDs, and slightly lower NFs than for the fully optimized MM-EDFs. At the highest input signal powers, 2.5 to 5 dBm, the MDG and NF performance meets or exceeds that for the fully optimized MM-EDFs, although higher pump powers are required. In summary, optimizing all MM-EDF properties (length, doping radii and pump mode powers) is most beneficial in reducing MDG, NF and pump power at low input signal powers.

TABLE 4
MULTIMODE AMPLIFIER PUMP POWERS OPTIMIZED AT TWO
WAVELENGTHS FOR 1 m-EDF WITH FULL-CORE DOPING

| EDFA input signal | Pump mode | power (mW) | MDG STD | σ_{g} (dB) | Mode-averaged | linear NF (dB) |
|---|---|---|---|---|---|---|
| power per mode (dBm) | LP_{12a, b} | LP_{31a, b} | 1530 nm | 1565 nm | 1530 nm | 1565 nm |
| −5.0 | 62.8 | 21.2 | 0.91 | 0.43 | 5.10 | 3.71 |
| −2.5 | 67.4 | 37.3 | 0.67 | 0.34 | 5.06 | 3.69 |
| 0 | 109.5 | 46.3 | 0.27 | 0.15 | 4.93 | 3.65 |
| 2.5 | 160.4 | 75.8 | 0.01 | 0.04 | 4.87 | 3.63 |
| 5.0 | 261.7 | 141.3 | 0.23 | 0.07 | 4.74 | 3.59 |

### B. Pump Coupler Performance

In this subsection, we quantify the pump-mode coupling efficiencies and signal-mode losses of the PC described in Section II-B, including the effect of splices to the transmission and amplification fibers. The constituent MSCs are analyzed using strongly coupled-mode theory, which accounts for non-orthogonality of the analyzed modes. Bound and leaky modes are considered to accurately model signal-mode losses. Results of coupled-mode theory are verified using BeamLab, a commercial beam propagation software. Splice losses are computed by considering overlaps of mismatched modal fields at the interfaces between the trench-less intermediate coupling fiber and the trench-assisted transmission and amplification fibers.

The pump-mode coupling efficiencies of the LP₀₁/LP₁₂ and LP₀₁/LP₃₁ MSCs are computed using the parameters in Table 2. The coupling efficiencies of the PC alone, and including the splice from the coupling fiber to the EDF, are shown in Table 5. The MSCs achieve high coupling efficiencies to the desired pump modes with small power transfer to other modes. Splicing causes only about 0.3%(0.01 dB) loss for both pump modes and weakly couples power between LP₁₂ and LP₃₁. Coherent power transfer between pump modes in the PC may affect amplifier performance, but is not accounted for here.

TABLE 5
PUMP MODE COUPLING EFFICIENCIES
OF THE PUMP COUPLER

| | | | |
|---|---|---|---|
| Pump | Pump | Coupler | Pump Coupler + Splice |

| Modes | LP₁₂ | LP₃₁ | LP₁₂ | LP₃₁ |
|---|---|---|---|---|
| LP₀₁/LP₁₂ | 99.7% | 0.3% | 98.6% | 1.1% |
| LP₀₁/LP₃₁ | 99.3% | 0.7% | 98.3% | 1.5% |

Signal-mode loss is caused either by splicing to and from the intermediate GI coupling fiber, or by signal-mode coupling into the SMFs of the MSCs or into leaky modes of the intermediate coupling fiber. These loss mechanisms will be referred to as splice loss and coupler loss, respectively. Only coupling to unbound modes contributes to splice loss, since splice-induced coupling between bound LP modes can be compensated by 12×12 multi-input multi-output (MIMO) equalization. Coupler loss is the sum of the signal mode losses from each MSC. Any signal-mode power remaining in the SMF or intermediate GI coupling fiber leaky modes at the end of each MSC is considered lost.

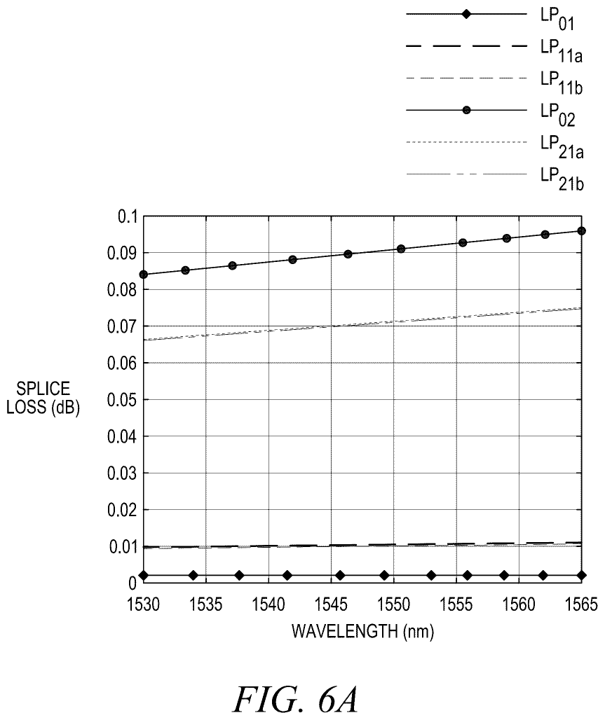

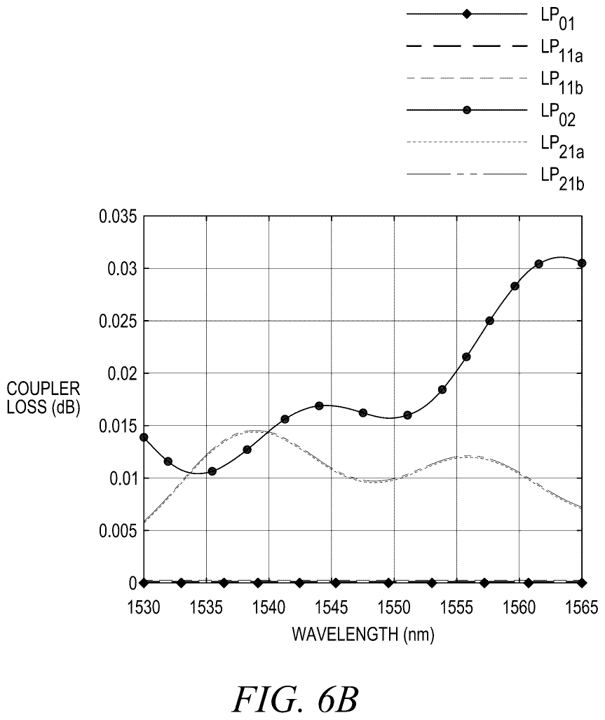

The splice losses and coupler losses for the six signal modes as a function of wavelength are shown in FIGS. 6(a) and 6(b), respectively. The legend in (a) also applies to (b). Splice loss is the more significant loss, inducing the highest losses of 0.09 dB and 0.07 dB loss to the LP₀₂ and LP₂₁ modes, respectively. These least-bound modes have the largest splice losses because their evanescent fields are most affected by the presence or absence of a trench, causing significant modal field mismatches. Coupler loss is less significant, but also has the greatest effect on the least-bound LP₀₂ and LP₂₁ modes, since their effective indices are closest to the effective index of the LP₀₁ mode in the SMF. The effective indices between these signal modes in the intermediate GI coupling fiber and those in the SMFs differ by about 10⁻³ over the C-band, preventing substantial signal loss.

FIG. 5(a) shows how MDL from the coupler and splice losses affects the overall MDG of the amplifier subsystem. At lower input signal powers, the coupler and splice losses increase the total amplifier MDG STD σ_{g} by roughly 0.05 dB over the C-band; at the best-performing powers of 0 dBm and 2.5 dBm, there is cross-over between the MDG STD σ_{g} curves with and without the coupler and splice losses, even as they remain below 0.15 dB; at the highest input signal power, where the ordering of modal gains is reversed and the optimized MM-EDFA provides the most gain to the higher-order LP₀₂ and LP₂₁ signal modes (see FIG. 4), the coupler and splice losses decrease the total amplifier MDG STD σ_{g} by roughly 0.05 dB.

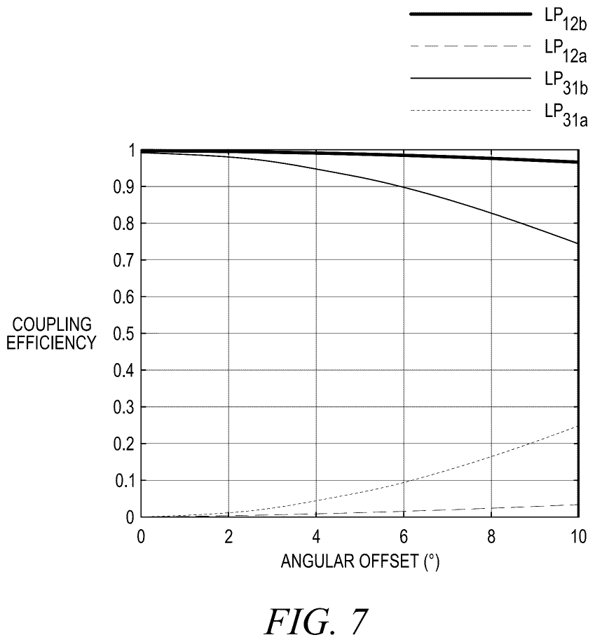

FIG. 5(b) shows how the coupler and splice losses affect the mode-averaged linear NF of the amplifier subsystem, adding roughly 0.04 dB across the C-band for all input signal powers. We consider the effect of possible errors in the angular separation between the two MSCs for the LP₁₂ modes or the two MSCs for the LP₃₁ modes in the PC. If the two MSCs for each LP-mode pair are not angularly separated by π/2 l+nπ/l for n={0, 1, 2, . . . }, the second MSC will couple into both the LPₗₘₐ and the LP_{lmb} modes, instead of just the LP_{lmb} mode. This is shown in FIG. 7. The LP₃₁ couplers are much more susceptible to angular offset than the LP₁₂ couplers, owing to a higher azimuthal order. Simultaneous coupling into both the LPₗₘₐ and LP_{lmb} modes will cause unwanted coherent addition of these modes in the amplifier, potentially increasing the MDG. Angular offsets within each MSC pair may be minimized by fabricating the two MSCs separately, cascading them, coupling mutually coherent 980 nm light into them and adjusting their angular orientations to minimize some signature of coherent addition at the output before fusion splicing them together.

An additional performance degradation may arise from refractive index profile errors in the intermediate GI fiber and/or the SMFs that constitute the MSCs. Such errors will cause propagation constant mismatches that reduce pump coupling efficiency. The reduced coupling efficiency can be completely overcome by increasing the pump laser powers, which will decrease system power efficiency but not affect the amplifier gain, NF or MDG.

### C. SDM System Design Implications

We now discuss the implications of the proposed amplification scheme for SDM system design in terms of MDG-limited capacity and power efficiency, drawing comparisons to parallel single-mode systems.

1) Impact of MDG on Capacity: As stated above, MDG tolerances for multimode amplifiers in transoceanic ultra-long haul systems are stringent, especially when considering non-ideal receiver architectures such as minimum mean-square error (MMSE)-based equalization. An effective SNR loss is defined here to relate the average capacity with MDG, C̅_{mdg}, to the ideal capacity without any MDG, C:

$${Δ}_{mdg} = 10 {log}_{10} ( SNR ) - 10 {log}_{10} ( {SNR}_{mdg} ) , \qquad ( 4 )$$

$$where SNR = D ( {2}^{C / D} - 1 ) and {SNR}_{mdg} = D ( 2 \frac{{\overline{C}}_{MDG}}{D} - 1 ) .$$

One can also relate Δ_{mdg} to an equivalent normalized capacity loss 1−C̅_{mdg}/C. Choosing a maximum tolerable SNR loss or capacity loss determines the maximum allowable per-amplifier MDG STD σ_{g} for a given link length and starting optical SNR.

We consider links of 50-km MMF spans with D=12 spatial and polarization modes, with our proposed amplifier subsystem placed at the end of each span. We assume strong, random mode coupling from span to span, which may require mode scrambling (see Section IV-C). The tolerable values of MDG STD σ_{g}, based on average capacities using optimal maximum-likelihood-(ML-) and MMSE-based receivers, are essentially the same as those for the CC-MCF studied in D. A. A. Mello et al., “Impact of polarization- and mode-dependent gain on the capacity of ultra-long-haul systems,” J. Lightw. Technol., vol. 38, no. 2, pp. 303-318, January 2020 with D=14, and hence we may evaluate the performance ofour amplifier subsystem against those requirements. As in FIGS. 10(c) and 10(d) of the D. A. A. Mello et al. reference, these estimates assume the most stringent SNR scaling regime under ASE and nonlinear noise accumulation, with an initial optical SNR per mode (SNR/D) of 31 dB, and we consider maximum effective SNR losses Δ_{mdg} of 1 or 2 dB.

Based on the worst-case MDG STD values over the C-band in FIG. 5(a), we observe that the MM-EDFAs optimized for 2.5 dBm input signal power per mode meet these tolerance requirements for all long-haul link lengths given either ML- or MMSE-based receivers, approaching the performance of PDG-limited single-mode EDFA-based systems. MM-EDFAs optimized for 0 dBm input signal power per mode would meet the tolerance requirements for all long-haul link lengths using ML receivers; however, they may suffer up to a 1 dB effective SNR loss in links over 10000 km using MM SE receivers. Likewise, MM-EDFAs optimized for 5 dBm input signal power per mode enable links of up to 4000 km (MMSE receiver-based) and 8000 km (ML receiver-based) with up to 1 dB effective SNR loss, or links of up to 8000 km (MMSE receiver-based) and ML-receiver links of any length with up to 2 dB effective SNR loss. Further sources of MDL in the amplifier subsystem or transmission fiber would shift these findings in favor of MM-EDFAs optimized for higher input signal powers.

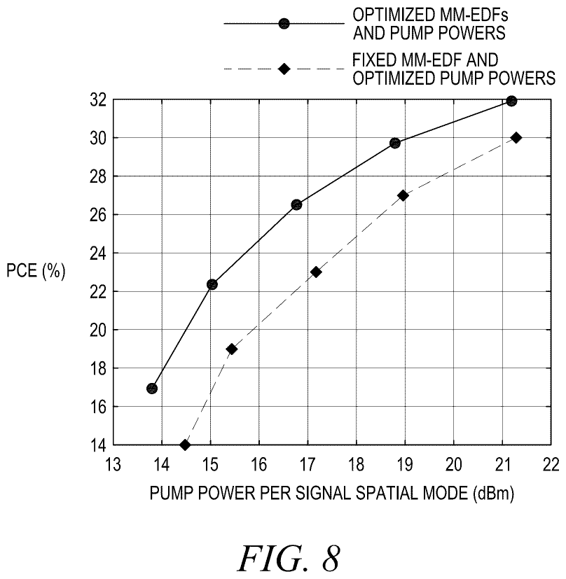

2) Power Efficiency: The pump powers per spatial signal mode, Pₚ/(D/2)=Pₚ/6, considered here are comparable to those in the parallel SMF systems. For the optimized MM-EDFAs of Table 3, providing at least 10 dB of gain for amplifier input signal powers per mode of 5, 2.5, 0, 2.5, and 5 dBm, the pump powers per signal mode are about 24, 32, 48, 75, and 132 mW, respectively. FIG. 8 shows, as a function of pump power per spatial mode, the MM-EDFA optical-to-optical PCE

$$PCE = \frac{{P}_{s , out} - {P}_{s , in}}{{P}_{p}} \qquad ( 5 )$$

where Pₚ is the total pump power, and P_{s,in} and P_{s,out} are the total input and output signal powers respectively, overall wavelengths and modes. In the PCE formula (5), the output signal power is taken directly after the MM-EDF, and does not include the loss of a multimode GFF or dynamic gain equalizer, unlike the single-mode EDFA PCE defined in. The PCEs of the fully optimized MM-EDFAs in FIG. 8 are otherwise similar to those of the single-mode EDFAs with equal pump power per signal spatial mode, being roughly equal near 17 dBm, while being a few percent lower at low pump powers and a few percent higher at high pump powers than the single-mode PCEs. For the amplifiers with fixed 1 m EDF length and full-core doping, and only pump mode powers optimized, the PCEs are roughly 2 to 4% lower than for the fully optimized MM-EDFAs. The gap widens at low pump powers, illustrating the power efficiency advantages of fully optimized MM-EDFAs at lower powers.

Pump farming is a strategy of combining the outputs of two or more pump laser diodes in a manifold of 3 dB couplers to enhance the reliability of pumping a fiber pair. The pump manifold for the proposed amplifier subsystem would differ from that in parallel single-mode SDM systems. Since each fiber pair requires eight pump laser diodes (four per fiber), the number of laser diodes and couplers is quadrupled; however, the number of laser diodes and couplers per spatial mode is reduced by a third compared to parallel single-mode systems.

The resulting number of fiber pairs may be estimated using the same formulae as in with a total pump power over all modes Pₚ, and compared to single-mode system performance, could provide roughly six times the capacity with the same fiber pair count, or equivalently, the same capacity using one sixth of the fiber pair count. This finding assumes overall power efficiencies equivalent to those in parallel SMF SDM experiments.

### IV. Discussion

### A. Manufacturing Methods

The GI MM-EDFs described herein may be manufactured using current commercial fabrication techniques. For instance, a modified chemical vapor deposition (MCVD) process may be employed with solution doping of the erbium and co-dopants. Since this process is generally limited by fiber geometry and homogeneity issues, it may be best suited to confined doping in step refractive index profiles. However, this fabrication limitation may be overcome with recent developments in MCVD, with gas-phase doping show significant promise. This method has been used to fabricate EDFs with independently defined, piece-wise constant refractive index and erbium doping profiles. Moreover, the vapor-phase chelate delivery technique has demonstrated the capability to realize rare-earth doping in graded refractive index silica fibers, and full-core step and ring doping of rare-earth ions in step-index silica fibers. Most recently, gas-phase atomic layer deposition of erbium nanofilms incorporating PbS as a co-dopant has enabled improved control of the concentration and uniformity of the Er³⁺ ions, while yielding beneficial amplifier properties of large gain bandwidth and low NF. Further extensions and refinements of such manufacturing techniques to improve their flexibility, uniformity and repeatability should allow the GI MM-EDFs described herein to be fabricated with ring erbium doping in a practical manner.

### B. Integration and Scaling

Integration is a key to scaling SDM systems beyond parallel SMFs. We have demonstrated, in one embodiment, amplification of six signal spatial modes while exciting only the fourth pump mode group, which comprises only four of the 15 available pump spatial modes. Notably, we choose higher-order pump modes, LP₁₂ and LP₃₁, because MSCs can efficiently couple the pump to them while inducing low signal-mode loss. This approach could be extended to amplify 10 signal spatial modes by designing MSCs to excite the fifth or sixth pump mode groups. By contrast, designing MSCs with low signal-mode loss for coupling into low-order pump modes, such as LP₀₁ or LP₁₁, becomes progressively more difficult for an increasing number of signal modes. CC-MCFs have demonstrated superior long-haul transmission properties, including large modal effective areas to minimize nonlinearity, and distributed strong mode coupling to minimize accumulation of GD and MDL/MDG. Multicore amplification, however, typically employs complicated, lossy fan-out/fan-in with single-mode amplifiers or inefficient, cladding-based pumping of multicore amplifiers. The wavelength- and mode-selective pumping scheme proposed herein may be extended to efficiently pump multicore amplifiers, provided all the cores are accessible from the fiber periphery. The number of coupling fibers would need to equal the number of cores, assuming there is negligible pump coupling between cores. This would not achieve the advantage demonstrated here with multimode amplifiers, where the number of pump spatial modes is smaller than the number of signal spatial modes amplified. For strong coupling between cores at the pump wavelength also, there may be added challenges controlling core-dependent saturation and pump propagation in the common cladding.

### C. Mode Coupling and Modal Dispersion

Achieving strong mode coupling and reducing modal dispersion are the main challenges facing MMF transmission systems. CC-MCFs offer strong mixing between all modes over short coupling lengths, so GD spreads accumulate with the square root of fiber length rather than linearly. The challenge of large GD spreads persists in MMFs, which have significant effective index differences between mode groups, so random perturbation-induced inter-group coupling is weak, although intra-group coupling is strong. Designing MMF refractive index profiles for strong inter- and intra-group coupling, while maintaining low guided-mode and high leaky-mode losses, is an outstanding challenge. Larger GD spreads result in higher digital signal processing (DSP) complexity and longer adaptation times at the receiver. MMF systems may thus offer the advantage of integration in the wet plant amplifier subsystem at the expense of the dry plant receiver DSP complexity, a trade-off counter to CC-MCF-based systems, which offer the advantage of strong, random coupling among all modes, but pose challenges in integrating amplification.

In MMF systems, strong, random mode coupling can be achieved by placing an LPFG or other type of mode scrambler in each span. Per-span mode scrambling, corresponding to a coupling length equal to the span length, is sufficient to minimize the accumulation of amplifier MDG and helps reduce the accumulation of GD spread with link distance. The GD reduction may be insufficient in transoceanic systems, so receiver-side DSP complexity may be high, with filters requiring several hundred taps to compensate for modal dispersion. Among options for mode scramblers, LPFGs offer the advantage of high integration, and may be placed in-line with the isolator and gain-flattening components in each span. To date, LPFGs have mode-averaged losses less than 0.45 dB and MDL STDs less than 0.36 dB over the C-band. These losses, especially the MDL, must be reduced several-fold to satisfy the requirements for transoceanic systems (see Section III-C1). This reduction may perhaps be achieved by a design strategy that suppresses coupling between guided and leaky modes.

### V. Illustrative SDM Optical Transmission System

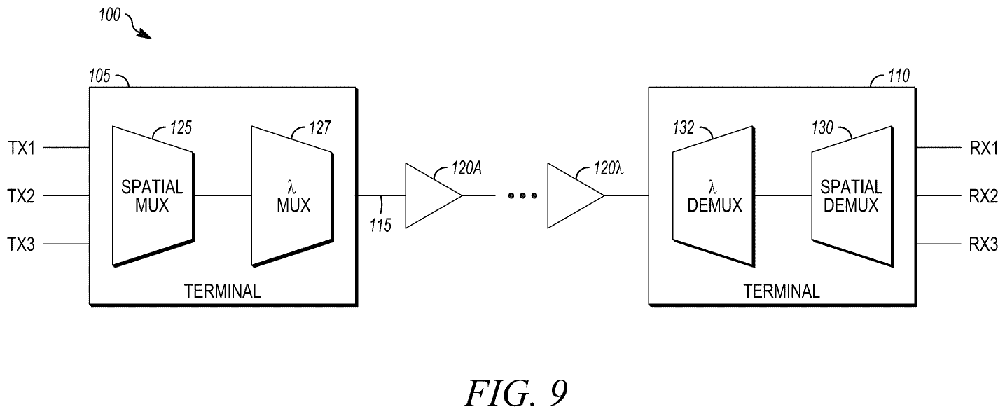

FIG. 9 illustrates one example of an SDM optical transmission system 100 that may employ the optical amplifier subsystem described herein. The SDM optical transmission system 100 uses hierarchical multiplexing that combines mode-division multiplexing (MDM) with wavelength-division multiplexing (WDM) The SDM system 100 includes terminals 105 and 110, optical cable 115, and optical amplifiers 120A . . . 120n. The system serves to transmit optical signals over the optical cable 115 in the direction from the terminal 105 to terminal 110. The exemplary system 100 may be, for example, a long-haul submarine system configured for transmitting the channels over a distance of 5,000 km, or more

Those skilled in the art will recognize that the system 100 has been depicted as a highly simplified point-to-point system for ease of explanation. For example, the system 100 is illustrated as transmitting in a single direction from the terminal 105 to terminal 110. The system may, of course, be configured for bi-directional communication and/or may be configured as a branched network. Moreover, systems and methods consistent with the subject matter described herein may be incorporated into a wide variety of network configurations including, for example, mesh and ring networks. Accordingly, the embodiments presented herein are provided only by way of illustration and not as a limitation on the subject matter described herein.

As shown, terminal 105 includes a spatial multiplexer 125 and wavelength multiplexer 127 and terminal i 10 includes a spatial demultiplexer 130 and wavelength demultiplexer 132. In a system configured for bi-directional communication terminals 103 and 109 each include multiplexers and demultiplexers. In general, terminals 105 and 110 also may include a variety of terminal equipment that depends on the type of SDM optical transmission system in which they are employed. For instance, in some cases the terminals 105 and 110 may be cable stations that have only terminating equipment such as power feed equipment and terminal line equipment. In other cases the terminals 105 and 110 may also include combinations of servers, routers and switches, as well as equipment for facilitating system management and for communication with network operations centers and points of presence (POPs).

The optical cable 115 includes at least one MMF or CC-MCF optical fiber that can support multiple wavelengths, with each wavelength having a plurality of modes. In some embodiments, such as long-haul submarine systems, for example, the optical cable 115 may include a power conductor designed to convey electrical power to the optical amplifiers 120A . . . 120n, optical add-drop-multiplexers (etc.), etc. coupled to optical cable 115. The configuration of the power conductor is common in undersea optical transmission systems where power must be carried along the run of optical cable 115 with the power being supplied from either or both ends of optical cable 115.

The terminal 105 may be configured to receive optical signals TX1, TX2 and TX3 and cause a plurality of signal wavelengths to be multiplexed by wavelength multiplexer 127 and launched into the optical fiber. Two or more modes are multiplexed on each of the signal wavelengths by a spatial multiplexer 125. For a multi-core fiber the different modes may be launched onto separate cores of the fiber, and for a multi-mode or few-mode fiber different modes are launched onto the multimode core of the optical fiber.

The optical amplifiers 120A . . . 120n may be coupled to optical cable 115 at a set spacing. The optical amplifiers 120A . . . 120n may be multimode optical amplifiers of the type described herein. The optical amplifiers 120A . . . 120n1 may include a gain medium such as sections of multimode doped fiber doped with e.g, erbium. When the separate sections of erbium-doped fiber are pumped by their associated pumps, the signals propagating in the different modes of the optical fiber are amplified via stimulated emission.

The amplified signal may then continue propagating within the optical fiber, being amplified periodically along the way, until received by the terminal 110. The wavelength demultiplexer 132 and spatial demultiplexer 130 in terminal 110 may reverse the multiplexing originally applied by the spatial multiplexer 125 and the wavelength multiplexer 127 to obtain signals that are representative of the original signals TX1, TX2 and TX3.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the teachings and advantages of the subject matter described herein. Other substitutions, modifications, changes and omissions may also be made in the design, operating conditions and arrangement of the various exemplary embodiments without departing from the scope of the present invention. For example, while the amplifier subsystem has been described in terms of a erbium-doped fiber gain medium, those of ordinary skill in the art will recognize that the systems and methods described herein are also applicable to other rare-earth doped fiber gain media.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

### APPENDIX A—OPTIMIZATION OBJECTIVE

The optimization objective (1) may be directly related to, and is one that maximizes, the capacity of a multimode system. We begin by writing an MDG-limited capacity metric

$$C = D {log}_{2} ( 1 + \frac{S N R}{D} {10}^{- {Δ}_{mdg / 10}} ) , \qquad ( 10 )$$

Where Δ_{mdg} is the effective SNR loss in dB caused by MDG. Assuming a signal power Ps per mode and noise power after K amplifiers given by Khv Δv NF, where h is Planck's constant, v is the channel frequency within the C-band, Δv is the channel bandwidth, and NF is the mode-averaged linear noise figure, the capacity metric becomes

$$C = D {log}_{2} ( 1 + \frac{{P}_{s}}{Khv Δ v} \frac{{10}^{- {Δ}_{\frac{mdg}{10}}}}{NF} ) . \qquad ( 11 )$$

The logarithm is one-to-one and monotonically increasing, so ignoring positive constants, maximizing capacity amounts to minimizing the sum of the effective SNR loss due to MDG and the amplifier NF expressed in dB, i.e., Δ_{mdg}+NF (dB).

For moderate-to-large MDG of σ_{mdg}≥3 dB, Δ_{mdg} scales roughly linearly with the MDG STD σ_{mdg} expressed in dB, with the constant of proportionality ranging from ˜½ at low SNR of 5 dB to ˜1 at high SNR of 20 dB. For a large number of spans, K>>1, assuming the link is in the strongly coupled regime with overall MDG ξ=√K σ_{g},

$${σ}_{mdg} = ξ \sqrt{1 + \frac{{ξ}^{2}}{12}} \approx \frac{K {σ}_{g}^{2}}{\sqrt{12}} . \qquad ( 12 )$$

Hence, maximizing capacity is equivalent to minimizing the sum of the amplifier MDG STD ag and the mode-averaged linear NF, both expressed in dB. The specific form of the objective function used herein reflects this principle, in addition to that of favoring desired values for gain and NF based on the link parameters, particularly the span attenuation.

The optimization capacity metric could include a dependence on the total optical bandwidth used, which we have dropped, assuming it to be fixed, corresponding to the C-band. Finally, for feed-power-limited MMF systems, the capacity metric may be altered to explicitly maximize the power efficiency, C/Pₚ, as was done for parallel SMF systems. Inclusion of a term controlling the pump power in the objective function was not found to significantly influence the optimized amplifier designs presented herein.

1. An optical fiber amplifier subsystem, comprising:
an optical fiber selected from the group consisting of a multimode fiber (MMF) and a coupled-core multi-core fiber (CC-MCF);
a gain medium configured to provide gain for Nₛₑ guided signal spatial modes in the optical fiber;
at least one pump light source configured to provide pump light at a pump wavelength to the gain medium;
a pump coupler configured to perform propagation constant matching to effect mode-selective evanescent field coupling of the pump light to Nₚₑ guided pump modes in the optical fiber, where Nₛₑ is an integer specifying a number of guided signal spatial modes to be excited and Nₚₑ is an integer specifying a number of guided pump spatial modes to be excited, and Nₚₑ<Nₛₑ and Nₚₑ>1.

2. The amplifier subsystem of claim 1, wherein the pump coupler is a fused glass pump coupler.

3. The amplifier subsystem of claim 1, wherein the pump coupler has a fiber core with a refractive index profile that renders unequal the propagation constants of different pump spatial modes that reside in common pump spatial mode groups to thereby provide mode-selective coupling.

4. The amplifier subsystem of claim 1, wherein the at least one pump light source includes a plurality of mutually incoherent light sources configured to launch pump light into different pump modes.

5. The amplifier subsystem of claim 1, wherein the gain medium includes one or more dopants distributed such that the gain medium has a doping profile, wherein the doping profile is a result of having been designed jointly with the powers of the respective pump modes.

6. The amplifier subsystem of claim 1, wherein the optical fiber is an MMF in which
Nₛₑ=6 (LP₀₁, LP_{11,a}, LP_{11,b}, LP_{21,a}, LP_{21,b}, LP₀₂ and the guided pump modes include modes from at least one of
pump mode group 4 (LP_{31,a}, LP_{31,b}, LP_{12,a}, LP_{12,b})
and
pump mode group 5 (LP_{41,a}, LP_{41,b}, LP_{22,a}, LP_{22,b}, LP₀₃).

7. The amplifier subsystem of claim 1, wherein the optical fiber is an MMF in which
Nₛₑ=10 (LP₀₁, LP_{11,a}, LP_{11,b}, LP_{21,a}, LP_{21,b}, LP₀₂, LP_{31,a}, LP_{31,b}, LP_{12,a}, LP_{12,b}) and the guided pump modes include modes from at least one of
pump mode group 5 (LP_{41,a}, LP_{41,b}, LP_{22,a}, LP_{22,b}, LP₀₃)
and
pump mode group 6 (LP_{51,a}, LP_{51,b}, LP_{32,a}, LP_{32,b}, LP_{13,a}, LP_{13,b}).

8. The amplifier subsystem of claim 1, wherein the optical fiber is a CC-MCF in which a number of cores N_{c} is one of 2, 3, 4, 5 and 6, and signal spatial supermodes associated with LP_{11,a} and LP_{11,b} are excited such that a total number of the signal spatial supermodes excited, given by Nₛₑ=2N_{c}, is one of 4, 6, 8, 10 and 12, and pump spatial modes associated with an axially symmetric mode are excited, such that a corresponding total number of pump spatial modes excited, given by Nₚₑ=N_{c}, is one of 2, 3, 4, 5 and 6.

9. The amplifier subsystem of claim 1, wherein the optical fiber is an CC-MCF in which a number of cores N_{c} is one of 2, 3, 4, 5 and 6, and signal spatial supermodes associated with LP₀₁, LP_{11,a} and LP_{11,b} are excited, such that the total number of signal spatial supermodes excited, given by Nₛₑ=3N_{c}, is one of 6, 9, 12, 15 and 18, and pump spatial modes associated with an axially symmetric mode are excited, such that the corresponding total number of pump spatial modes excited, given by Nₚₑ=N_{c}, is one of 2, 3, 4, 5 and 6.

10. The amplifier subsystem of claim 1, wherein the gain medium includes an erbium-doped fiber.

11. A spatial-division multiplexing (SDM) optical transmission system, comprising:
first and second terminals;
an optical path operatively coupling the first terminal to the second terminal and including at least one optical fiber configured to support a plurality of spatial modes at a given optical wavelength; and
at least one multimode optical amplifier subsystem disposed along the optical path for amplifying the plurality of spatial modes propagating in the optical fiber, the at least one multimode optical amplifier subsystem including:
a gain medium configured to provide gain for Nₛₑ guided signal spatial modes in the optical fiber;
at least one pump light source configured to provide pump light at a pump wavelength to the gain medium;
a pump coupler configured to perform propagation constant matching to effect mode-selective evanescent field coupling of the pump light to Nₚₑ guided pump spatial modes in the optical fiber,
where Nₛₑ is an integer specifying a number of guided signal spatial modes to be excited and Nₚₑ is an integer specifying a number of guided pump spatial modes to be excited, and Nₚₑ<Nₛₑ and Nₚₑ>1.

12. The SDM optical transmission system of claim 11, wherein the optical fiber is selected from the group consisting of a multimode fiber (MMF) and a coupled-core multi-core fiber (CC-MCF).

13. The SDM optical transmission system of claim 11, wherein the pump coupler is a fused glass pump coupler.

14. The SDM optical transmission system of claim 11, wherein the pump coupler has a fiber core with a refractive index profile that renders unequal the propagation constants of different pump spatial modes that reside in common pump spatial mode groups to thereby provide mode-selective coupling.

15. The SDM optical transmission system of claim 11, wherein the at least one pump light source includes a plurality of mutually incoherent light sources configured to launch pump light into different pump modes.

16. The SDM optical transmission system of claim 11, wherein the gain medium includes one or more dopants distributed such that the gain medium has a doping profile, wherein the doping profile is a result of having been designed jointly with the powers of the respective pump modes.

17. The SDM optical transmission system of claim 11, wherein the optical fiber is an MMF in which
Nₛₑ=6 (LP₀₁, L_{11,a}, LP_{11,b}, LP_{21,a}, LP_{21,b}, LP₀₂ and the guided pump modes include modes from at least one of
pump mode group 4 (LP_{31,a}, LP_{31,b}, LP_{12,a}, LP_{12,b})
and
pump mode group 5 (LP_{41,a}, LP_{41,b}, LP_{22,a}, LP_{22,b}, LP₀₃).

18. The SDM optical transmission system of claim 11, wherein the optical fiber is an MMF in which
Nₛₑ=10 (LP₀₁, LP_{11,a}, LP_{11,b}, LP_{21,a}, LP_{21,b}, LP₀₂, LP_{31,a}, LP_{31,b}, LP_{12,a}, LP_{12,b}) and the guided pump modes include modes from at least one of
pump mode group 5 (LP_{41,a}, LP_{41,b}, LP_{32,a}, LP_{32,b}, LP_{13,a}, LP_{13,b})
and
pump mode group 6 (LP_{51,a}, LP_{51,b}, LP_{32,a}, LP_{32,b}, LP_{13,a}, LP_{13,b}).

19. The SDM optical transmission system of claim 11, wherein the optical fiber is a CC-MCF in which a number of cores N_{c} is one of 2, 3, 4, 5 and 6, and signal spatial supermodes associated with LP_{11,a} and LP_{11,b} are excited such that a total number of the signal spatial supermodes excited, given by Nₛₑ=2N_{c}, is one of 4, 6, 8, 10 and 12, and pump spatial modes associated with an axially symmetric mode are excited, such that a corresponding total number of pump spatial modes excited, given by Nₚ=N_{c}, is one of 2, 3, 4, 5 and 6.

20. The SDM optical transmission system of claim 11, wherein the optical fiber is an CC-MCF in which a number of cores N_{c} is one of 2, 3, 4, 5 and 6, and signal spatial supermodes associated with LP₀₁, LP_{11,a} and LP_{11,b} are excited, such that the total number of signal spatial supermodes excited, given by Nₛₑ=3N_{c}, is one of 6, 9, 12, 15 and 18, and pump spatial modes associated with an axially symmetric mode are excited, such that the corresponding total number of pump spatial modes excited, given by Nₚₑ=N_{c}, is one of 2, 3, 4, 5 and 6.

21. The SDM optical transmission system of claim 11, wherein the gain medium includes an erbium-doped fiber.
